(19) United States
(12) Patent Application Publication
(10) Pub. No.: US 2014/0101776 A1
(43) Pub. Date: Apr. 10, 2014

(54) Digital Asset Distribution Media

(71) Applicant: RED.COM, Inc., Irvine, CA (US)

(72) Inventor: Jon A. Farhat, Burbank, CA (US)

(73) Assignee: RED.COM, Inc., Irvine, CA (US)

(21) Appl. No.: 13/926,354

(22) Filed: Jun. 25, 2013

Related U.S. Application Data
(60) Provisional application No. 61/712,115, filed on Oct. 10, 2012.

(51) Int. Cl. G06F 21/10

(52) U.S. Cl. CPC G06F 21/10
USPC 726/27

(57) ABSTRACT

Content distribution devices and systems are presented. A content distribution device can include a memory storing a secured media asset where a media player is restricted from fully rendering the asset. The memory of the device can also store an asset descriptor key, which can be used, in conjunction with media player identification information, to obtain an asset access key from a rights management server. The asset access key can include authorization parameters that govern an extent to which the media player can render the asset.

### FIELD OF THE INVENTION

The field of the invention is asset distribution technologies.

### BACKGROUND

In the age of digital content distribution, entities who own one or more rights with respect to content must have their rights respected. Known methods of rights management attempt to limit distribution of digital assets by intimately binding assets with authorization information.

U.S. Pat. No. 7,841,538 to Robertson et al. titled “Transaction Product with Memory”, filed Oct. 31, 2007, describes a transaction product having a memory storing a movie bound with an account identifier. Unfortunately, such an approach tightly binds the asset to a user or an account, which severely limits distribution of the asset.

U.S. patent application publication 2011/0179204 to Hulbert et al. titled “USB Autorun Device”, filed Jan. 6, 2011, describes a standardized USB device having a memory capable of storing an asset. Unfortunately, Hulbert also requires strong key management.

Others have also put forth effort toward providing movies via USB devices. For example, FlixChip™ (see URL www.flixchip.com) provides movies to users on a thumb drive. The FlixChip approach also requires extensive key management, which restricts distribution of content.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The applicant has appreciated that separating key management from the distribution device itself allows for easy access by a content consumer and does not restrict access to the asset. For example, a secured asset can be distributed at will without concern for rights management. When a consumer chooses to enjoy the content of the asset, the asset can be unlocked at play time as discussed further below.

Thus, there is still a need for content distribution devices that do not restrict distribution of assets while still providing authorization for rendering the asset.

### SUMMARY OF THE INVENTION

The inventive subject matter provides apparatus, systems and methods in which one can leverage a content distribution device to provide digital assets to a content consumer. One aspect of the inventive subject matter includes a content distribution device comprising a computer readable memory storing a secured asset and an asset descriptor key. The device further includes an asset access interface through which a media asset or other rendering device can gain access to the asset. Some devices also include a controller coupled with the memory and the interface. Although a media player can obtain a copy of the asset, the memory of the device lacks sufficient information to enable the media player to fully render the asset. The controller (e.g., a USB controller, etc.) manages communication protocols with the media player and can provide the asset and asset descriptor key to the media player upon request. The content distribution device can be a member of a content distribution system that includes a right management server. In order for the player to be enabled to render the asset, an agent within the media player can provide player identification information or the asset descriptor key to the server. In response, the server can generate or otherwise obtain an asset access key, which in turn can be sent back to the agent. The agent uses the asset access key to authorize the media player to render the asset according to authorization parameters encoded within the asset access key.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of content distribution device.

FIG. 2 is a schematic of a content distribution ecosystem.

### DETAILED DESCRIPTION

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including providing electronic signals that authorized a media player to render a media asset located on a content distribution device.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. In addition, the terms “coupled to” and “coupled with” are also used euphemistically to mean “communicatively coupled with” where two or more networked devices are able to exchange data over a network, possibly via one or more intermediary devices.

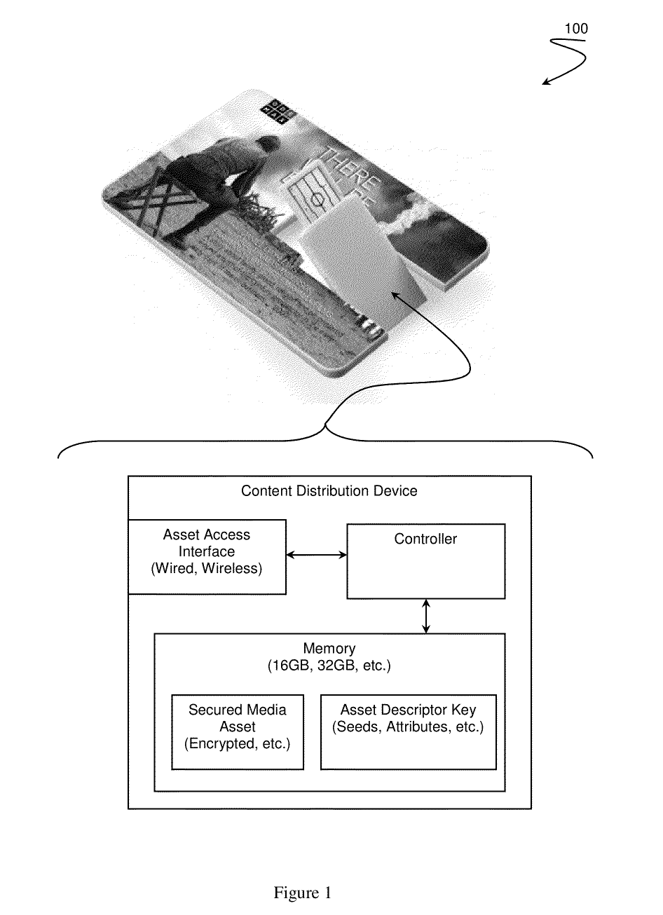

In FIG. 1 content distribution device 100 comprises a memory, an asset access interface, and a controller. In the example shown, device 100 comprises a housing in the form of a credit card form factor that at least partially encapsulates the component of the device.

The memory of device 100 stores one or more secured assets. The secured asset can comprise various forms of data representing different types of content. For example, the secured asset can include game data, application data, an application, image data, movie data, audio data, video data, kinesthetic data, operating system data, or other types of data modalities. The memory can comprise one or more types of suitable media possibly including read-only memory, RAM, a solid state drive, flash, or other types of medium. Read-only memory is considered advantageous because it allows for intimately binding the secured media asset with device 100, which can increase the value of the device itself or its collectible nature.

The secured asset is secured with respect to restricting a media player from fully rendering content associated with the asset. In some embodiments, the asset can be completely or partially encrypted with a key. Thus, the memory of device 100 lacks sufficient information to enable a media player to fully render the secured asset. One should appreciate that although the assets is secured to restrict rendering, the asset is can be made available for distribution or copying. Such an approach is considered advantageous because it allows the asset to be distributed freely, but still secures the rights of owner's of the content within the asset.

The memory can also store one or more asset descriptor keys. The asset descriptor key can be an encoded token storing information that describes the nature of the secured asset. The descriptor key does not represent key that unlocks the secured asset. Example descriptor keys can include metadata describing the asset (e.g., type, name, rights owners, features, capabilities, genre, actors, etc.). Thus, the descriptor key can be considered to store one or more attribute identifiers that describe the nature of the asset or its contents. For example, the attributes identifiers could adhere to a system wide common, normalized namespace so that one asset can be compared to another asset.

Consider a scenario where a content consumer wishes to compare assets with respect to genre. The descriptor keys of each asset can be tagged with a genre identifier (e.g., horror, sci-fi, romance, historical, etc.). One or more genre identifiers can then be used to search for other assets having similar genre identifiers. In such scenarios, the asset attribute identifiers can be used as seeds for automatically populating a user's media player with similar secured assets.

A media player can gain access to the secured media asset via the asset access interface. In the example shown, the asset access interface includes a USB interface, which can be plugged into a USB port of a suitably equipped media player (e.g., game console, smart phone, computer, tablet, set top box, appliance, television, disc player, etc.). Via a communication protocol (e.g., USB protocol), the player can coordinate access to the secured media asset with the device's controller. In response to a request from the media player, the controller transmits at least a portion of the asset or the asset descriptor key to the media player. In some embodiments a controller might not be present as device 100 could be a passive device.

Although the asset interface is illustrated as a USB interface, other types of wired interfaces are also contemplated including a Firewire interface, a serial interface, an Ethernet interface, an optic fiber interface, or other type of wired interface. In other embodiments, the asset interface can comprise a wireless interface. Example wireless interfaces include Bluetooth interface, a 802.11 interface, a WiMAX interface, a WiGIG interface, a wireless USB interface, an IrDA interface, Zigbee interfaces, or other types of wireless interfaces.

FIG. 1 illustrates device 100 as being approximately sized and dimensioned according to a credit card form factor. Other types of housings are also contemplated. For example the housing can include a figurine (e.g., action figure, toy, etc.), a dongle, a piece of jewelry (e.g., earring, cufflink, charm, broach, etc.), or other type of housing. Consider a scenario where device 100 stores a children's movie. Device 100 can comprises a figurine of the main character of the movie as a toy.

In view that the asset can be distributed freely because it is secured so that it can not be accessed unless authorized, the housing can take on other characteristics that promote distribution. In such scenarios, the housing can be produced according to a rarity policy to increase the collectable nature of the device itself. Further, the asset descriptor key can include verification ID that validates or certifies the rarity level of the device.

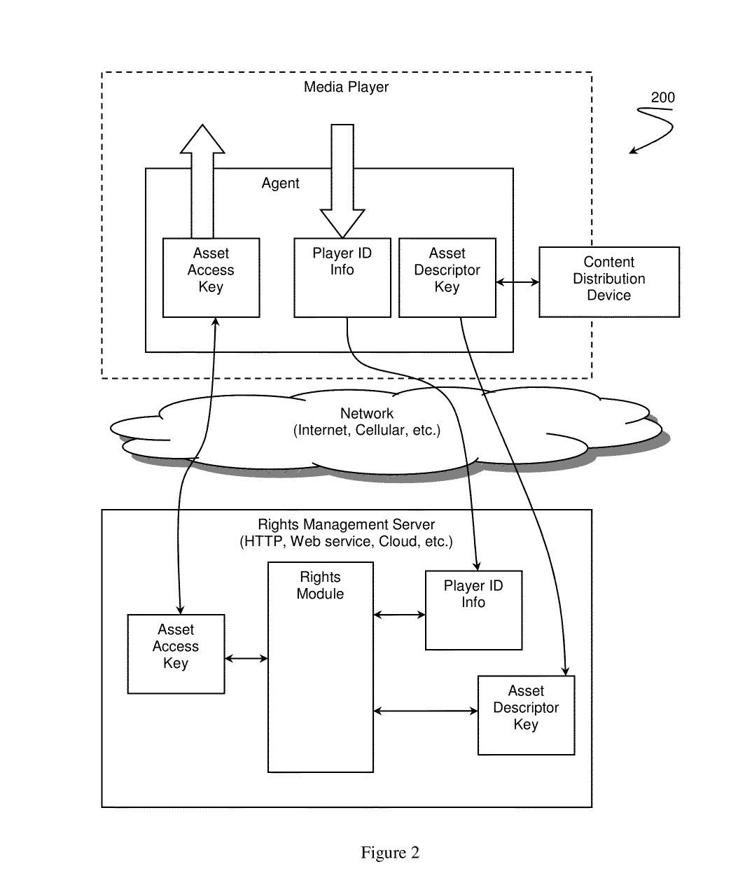

FIG. 2 presents ecosystem 200 in which contemplated content distribution devices exist. For example, content distribution devices can be a member of a content distribution system that includes a rights management server and an agent deployed within a media player. In some embodiments, the agent is a member of the system while the media player is not in the system.

When a content distribution device is coupled with the media player, the agent can obtain the asset descriptor key located on the device. Further, the agent can obtain media player identification information. The agent transmits the player information or asset descriptor key, or other related data, to the rights management server. The server uses the player information and the asset descriptor key to determine what rights the player should have with respect to the asset. The server, possibly via a rights module, can generate an access key for the secured asset and targeting the agent.

The asset access key can be generated or otherwise obtained as a function of the player information and the asset descriptor key. The key can be encoded with parameters governing how or to what extent the player has rights to render the asset. For example, the key can include a decrypt key that allows the agent to decode the secured asset. Further, the key can include parameters governing other aspects of rendering including display resolution, advertisement control, time shift capabilities, sound levels, or other aspects of rendering.

The rights server provides the asset access key to the agent. In turn, the agent controls how the media player renders the secured asset to a user according to the authorization parameters of the asset access key.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A content distribution device for a media player comprising:
a memory storing a secured media asset and an asset descriptor key;
an asset access interface configured to couple with the media player;
a controller coupled with the interface and configured to transmit over the asset access interface to the media player at least one the following: at least a portion of the secured media asset and the asset descriptor key; and
wherein the memory the information stored in the memory restricts the media player from fully rendering the asset.

2. The device of claim 1, wherein the asset access interface comprises a wired interface.

3. The device of claim 2, wherein the wired interface comprises at least one of the following: a USB interface, a Firewire interface, a serial interface, an Ethernet interface, and an optic fiber interface.

4. The device of claim 1, wherein the asset access interface comprises a wireless interface.

5. The device of claim 4, wherein the wireless interface includes at least one of the following: a Bluetooth interface, a 802.11 interface, a WiMAX interface, a WiGIG interface, a wireless USB interface, and an IrDA interface.

6. The device of claim 1, further comprising a housing that at least partially encapsulates the memory, the interface, and the controller.

7. The device of claim 6, wherein the housing is approximately sized and dimensioned according to a credit card form factor.

8. The device of claim 6, wherein the housing is approximately sized and dimensioned according a figurine form factor.

9. The device of claim 6, wherein the housing comprises a dongle.

10. The device of claim 6, wherein the housing comprises an article of jewelry.

11. The device of claim 1, wherein the housing comprises a collectible rarity.

12. The device of claim 11, wherein an asset descriptor key includes a rarity level of the housing.

13. The device of claim 1, wherein the asset descriptor key comprises asset attribute identifiers.

14. The device of claim 13, wherein the asset attribute identifiers adhere to a common, normalized asset namespace.

15. The device of claim 13, wherein the asset attribute identifiers includes content distribution seeds.

16. The device of claim 1, wherein the memory comprises a read-only memory.

17. The device of claim 1, wherein the secured media asset comprises movie data.

18. The device of claim 1, wherein the secured media asset includes at least one of the following: game data, application data, an application, image data, audio data, video data, kinesthetic data, and operating system data.

19. The device of claim 1 composing a content distribution system that includes a rights management server configured to:
communicatively coupled with the media player;
receive player identification information and the asset descriptor key from the media player;
obtain an asset access key as a function of the player identification information and the asset descriptor key; and
provide the asset access key to the media player enabling the media player to render the asset.

20. The device of claim 1, wherein the content distribution system further comprises a media agent disposed within the media player and configured to command the media player to render the asset according to parameters encoded within the asset access key.
